(19) United States
(12) Patent Application Publication
(10) Pub. No.: US 2026/0111066 A1
(43) Pub. Date: Apr. 23, 2026

(54) CONTROL DEVICE, CONTROL SYSTEM, AND CONTROL METHOD

(71) Applicant: MITSUBISHI ELECTRIC CORPORATION, Tokyo (JP)

(72) Inventors: Takahiro ITO, Tokyo (JP); Shin NAKAMURA, Tokyo (JP); Shinji ITO, Tokyo (JP); Yuki YAMANOUCHI, Tokyo (JP); Yu NAKANISHI, Tokyo (JP); Akinori WADA, Tokyo (JP); Yudai NAKANISHI, Tokyo (JP); Takeru YOSHIDA, Tokyo (JP); Daiki HARADA, Tokyo (JP)

(73) Assignee: MITSUBISHI ELECTRIC CORPORATION, Tokyo (JP)

(21) Appl. No.: 19/477,226

(22) PCT Filed: Jul. 20, 2023
(86) PCT No.: PCT/JP2023/026611

§ 371 Date: Oct. 21, 2025

(51) Int. Cl. G06F 1/28; G06F 1/30; H02J 9/06

(52) U.S. Cl. CPC G06F 1/28; G06F 1/30; H02J 9/068

(57) ABSTRACT

A CPU includes an auxiliary power supply, a power receiver, a storage, an abnormality detector that detects an abnormality occurring in at least one device of devices including the CPU and a plurality of external devices including a main power supply unit and stores, into the storage, abnormality data including data indicating the device with the abnormality, an indication controller that provides, based on the abnormality data, information indicating the device with the abnormality using an indicator, and a power supplier that supplies power to the storage and the indication controller. The storage and the indication controller operate on power supplied from the power supplier. The power supplier supplies power from the main power supply unit when the power receiver receives power from the main power supply unit, and supplies power from the auxiliary power supply when the power receiver receives no power from the main power supply unit.

### TECHNICAL FIELD

The present disclosure relates to a control device, a control system, and a control method.

### BACKGROUND ART

A known technique is used for a control system to indicate a portion with an abnormality and support maintenance for responding to such an abnormality. For example, Patent Literature 1 describes a programmable logic controller (PLC) that indicates a portion with an abnormality in a system when detecting the abnormality.

### CITATION LIST

### Patent Literature

Patent Literature 1: Unexamined Japanese Patent Application Publication No. 2011-008496

### SUMMARY OF INVENTION

### Technical Problem

The maintenance for responding to an abnormality may be performed without any power from a main power supply to the device. For example, the main power supply may be turned off to prevent an electric shock or an abnormal operation during inspection of the device, or may have a failure and stop supplying power to the device.

The technique described in Patent Literature 1 does not indicate a portion with an abnormality when no power is supplied from the main power supply, and thus cannot sufficiently support the maintenance.

In response to the above issue, an objective of the present disclosure is to provide a control device and other techniques that can indicate a portion with an abnormality without any power from a main power supply.

### Solution to Problem

To achieve the above objective, a control device according to an aspect of the present disclosure includes an auxiliary power supply, power receiving means, storage means, abnormality detection means, indication control means, and power supply means. The power receiving means is for receiving power from a main power supply. The abnormality detection means is for detecting an abnormality occurring in at least one device of devices. The devices include the control device and a plurality of external devices. The plurality of external devices include the main power supply. The abnormality detection means is for storing, into the storage means, abnormality data about the abnormality including data indicating the at least one device with the abnormality. The indication control means is for providing, based on the abnormality data stored in the storage means, information indicating the at least one device with the abnormality using first indication means. The power supply means is for supplying power to the storage means and the indication control means. The storage means and the indication control means operate on power supplied from the power supply means. The power supply means supplies power from the main power supply when the power receiving means receives power from the main power supply. The power supply means supplies power from the auxiliary power supply when the power receiving means receives no power from the main power supply.

### Advantageous Effects of Invention

The techniques according the above aspect of the present disclosure can indicate a portion with an abnormality without any power from the main power supply.

### BRIEF DESCRIPTION OF DRAWINGS

FIG. 1 is a diagram of a control system according to Embodiment 1 of the present disclosure, illustrating the overall structure;

FIG. 2 is a flowchart of example processing of supplying power using a CPU according to Embodiment 1 of the present disclosure; and

FIG. 3 is a diagram of a control system according to Embodiment 2 of the present disclosure, illustrating the overall structure.

### DESCRIPTION OF EMBODIMENTS

A control system according to one or more embodiments of the present disclosure is described below with reference to the drawings. Like reference signs denote like or corresponding components in the drawings.

### Embodiment 1

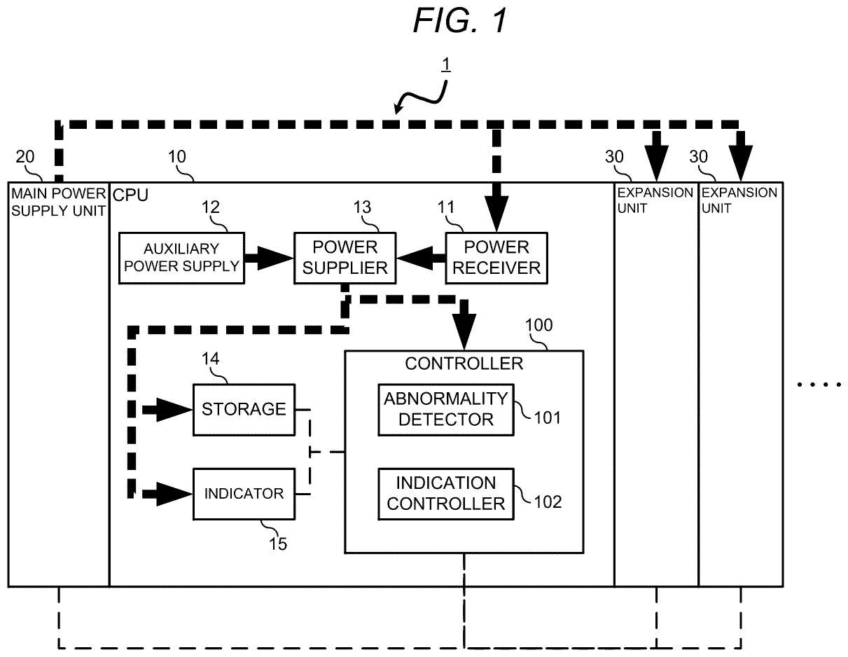

A control system 1 according to Embodiment 1 is described with reference to FIG. 1. In FIG. 1, the bold dashed arrows indicate the connection(s) of power supply lines and the flow of power. The thin dashed lines indicate the connection(s) of communication lines.

The control system 1 is implemented by a programmable logic controller (PLC) including various units. The control system 1 controls sensors, actuators, and other devices (not illustrated). The control system 1 includes a central processing unit (CPU) 10, a main power supply unit 20, and one or more expansion units 30. The main power supply unit 20 supplies power to the CPU 10 and the expansion units 30. The CPU 10 is connected to the main power supply unit 20 and the expansion units 30 for mutual communication. The CPU 10, the main power supply unit 20, and the expansion units 30 form the PLC. The control system 1 is an example of a control system in an aspect of the present disclosure.

The CPU 10 centrally controls the control system 1 as the PLC. The CPU 10 normally operates on power supplied from the main power supply unit 20. The CPU 10 executes a program to communicate with the expansion units 30. The CPU 10, for example, acquires sensor values from a sensor (not illustrated) or controls an actuator (not illustrated).

The CPU 10 communicates with the main power supply unit 20 and the expansion units 30 to detect an abnormality in the main power supply unit 20 or in the expansion units 30. When detecting an abnormality in the main power supply unit 20 or in the expansion units 30, the CPU 10 provides information about the abnormality (or indicates the abnormality) to a user. The information about the abnormality includes information at least indicating a unit with the abnormality. This indication can be performed without any power from the main power supply unit 20. The functional components of the CPU 10 and the details of abnormality detection and abnormality indication are described later. The CPU 10 is an example of a control device in an aspect of the present disclosure.

The main power supply unit 20 supplies power to the CPU 10 and the expansion units 30. The main power supply unit 20 is connected to the CPU 10 for mutual communication. The CPU 10 can detect an abnormality in the main power supply unit 20 through communication. The user can stop supplying power from the main power supply unit 20 as appropriate. In maintenance, for example, the user can turn off a power supply switch (not illustrated) in the main power supply unit 20 and stop supplying power from the main power supply unit 20 to prevent, for example, an electric shock or an abnormal operation. The main power supply unit 20 is an example of a main power supply or an external device in an aspect of the present disclosure.

The expansion units 30 operate on power supplied from the main power supply unit 20. The expansion units 30 are connected to the CPU 10 for mutual communication. The expansion units 30 each operate under the corresponding control performed by the CPU 10. The CPU 10 can detect, through communication, an abnormality in each of the expansion units 30. The expansion units 30 are each, for example, an input-output unit or a network communication unit. The expansion units 30 are each an example of an external device in an aspect of the present disclosure.

The functional components of the CPU 10 are described below. The CPU 10 includes a power receiver 11, an auxiliary power supply 12, a power supplier 13, a storage 14, an indicator 15, and a controller 100.

The power receiver 11 receives power from the main power supply unit 20. The power receiver 11 supplies the received power to the power supplier 13. When the power receiver 11 receives no power from the main power supply unit 20, the power receiver 11 stops supplying power to the power supplier 13. When, for example, the main power supply unit 20 with an abnormality stops supplying power or the power supply switch in the main power supply unit 20 is off, the power receiver 11 stops supplying power to the power supplier 13. The power receiver 11 is an example of power receiving means in an aspect of the present disclosure.

The auxiliary power supply 12 includes a power source such as a dry-cell battery, a rechargeable battery, or a supercapacitor (not illustrated). The auxiliary power supply supplies power from the power source to the power supplier 13. The auxiliary power supply 12 is an example of an auxiliary power supply in an aspect of the present disclosure.

The power supplier 13 supplies power to the storage 14, the indicator 15, and the controller 100. When the power supplier 13 receives power from the power receiver 11, or in other words, when the power receiver 11 receives power from the main power supply unit 20, the power supplier 13 supplies power from the power receiver 11 to the storage 14, the indicator 15, and the controller 100. When the power supplier 13 receives no power from the power receiver 11, or in other words, when the power receiver 11 receives no power from the main power supply unit 20, the power supplier 13 supplies power from the auxiliary power supply 12 to the storage 14, the indicator 15, and the controller 100. In other words, the power supplier 13 switches, based on whether the power receiver 11 receives power from the main power supply unit 20, between the power sources for supplying power to the storage 14, the indicator 15, and the controller 100. The power supplier 13 is an example of power supply means in an aspect of the present disclosure.

The storage 14 stores abnormality data generated by an abnormality detector 101 (described later). The storage 14 operates on power supplied from the power supplier 13. The storage 14 is implemented by, for example, a flash memory. The storage 14 is an example of storage means in an aspect of the present disclosure.

The indicator 15 provides, based on an indication from an indication controller 102 (described later), information about an abnormality occurring in the control system 1 to the user. The indicator 15 particularly provides information indicating a unit with the abnormality. The indicator 15 operates on power supplied from the power supplier 13. The indicator 15 is, for example, a display that can display information about the abnormality as an image. In some embodiments, the indicator 15 may include multiple lamps each indicating the corresponding unit with the abnormality or the corresponding type of the abnormality. In some embodiments, the indicator 15 may be a speaker that provides information about the abnormality with a voice. The indicator 15 is an example of first indication means in an aspect of the present disclosure.

The controller 100 centrally controls the CPU 10. The CPU 10 operates on power supplied from the power supplier 13. The CPU 10 includes the abnormality detector 101 and the indication controller 102.

The abnormality detector 101 communicates with the main power supply unit 20 and the expansion units 30 to detect an abnormality in the main power supply unit 20 or the expansion units 30. The abnormality detector 101 also detects an abnormality in the CPU 10. When detecting an abnormality in the main power supply unit 20, the expansion units 30, or the CPU 10, the abnormality detector 101 generates abnormality data as data about the abnormality and stores the abnormality data into the storage 14. The abnormality data includes data at least indicating a unit with the abnormality. The abnormality detector 101 operates on power supplied from the power supplier 13. The abnormality detector 101 is an example of abnormality detection means in an aspect of the present disclosure.

When, for example, the abnormality detector 101 cannot communicate with one unit among the main power supply unit 20 and the one or more expansion units 30, the abnormality detector 101 detects the unit with an abnormality in communication. In this case, the abnormality detector 101 generates abnormality data including data indicating that the abnormality occurs in the unit, and stores the abnormality data into the storage 14. In some embodiments, the abnormality detector 101 may communicate with each unit to diagnose the unit, and detect an abnormality based on whether the corresponding diagnostic result includes the abnormality. In some embodiments, the abnormality detector 101 may receive no signal expected to be output from a portion of a circuit in the CPU 10, and detect an abnormality in the circuit. In this case, the abnormality detector 101 generates abnormality data including data indicating that the abnormality occurs in the circuit, and stores the abnormality data into the storage 14.

When the abnormality detector 101 detects no abnormality and the storage 14 stores past abnormality data, the abnormality detector 101 deletes the past abnormality data.

The indication controller 102 refers to abnormality data stored in the storage 14, and controls the indicator 15 to provide information about an abnormality based on the abnormality data. The indication controller 102 particularly provides information indicating a unit with the abnormality using the indicator 15. The indication controller 102 operates on power supplied from the power supplier 13. The indication controller 102 is an example of indication control means in an aspect of the present disclosure.

The indication controller 102 performs no indication when the storage 14 stores no abnormality data. Thus, when no abnormality is detected, the CPU 10 performs no indication.

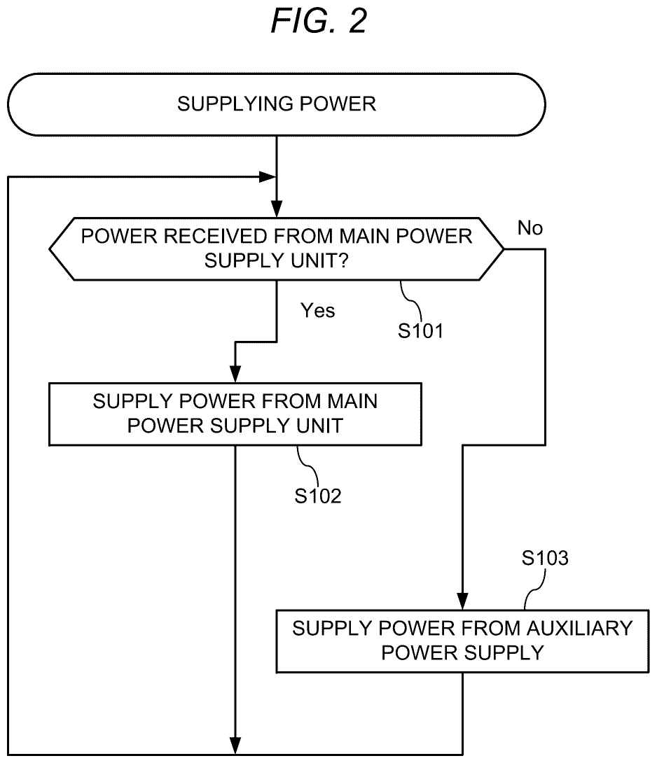

Example processing of supplying power using the CPU 10 is now described with reference to FIG. 2. The processing illustrated in FIG. 2 continues to be performed while the CPU 10 is operating.

The power supplier 13 in the CPU 10 determines whether the power receiver 11 receives power from the main power supply unit 20 (step S101). As described above, this determination is based on whether the power receiver 11 supplies power to the power supplier 13.

When receiving power from the main power supply unit 20 (Yes in step S101), the power supplier 13 supplies power from the power receiver 11, or in other words, power from the main power supply unit 20, to the storage 14, the indicator 15, and the controller 100 (step S102). The processing in step S101 and the processing in subsequent steps are then repeated.

When receiving no power from the main power supply unit 20 (No in step S101), the power supplier 13 supplies power from the auxiliary power supply 12 to the storage 14, the indicator 15, and the controller 100 (step S103). The processing in step S101 and the processing in subsequent steps are then repeated.

Through the processing, the storage 14, the indicator 15, and the controller 100 operate on, without any power from the main power supply unit 20, power from the auxiliary power supply 12. Thus, the abnormality detector 101 detects an abnormality and stores abnormality data into the storage 14. The indication controller 102 and the indicator 15 provide information about the abnormality, or particularly provide information indicating a unit with the abnormality. In other words, the CPU 10 can indicate, without any power from a main power supply, a portion with the abnormality.

### Embodiment 2

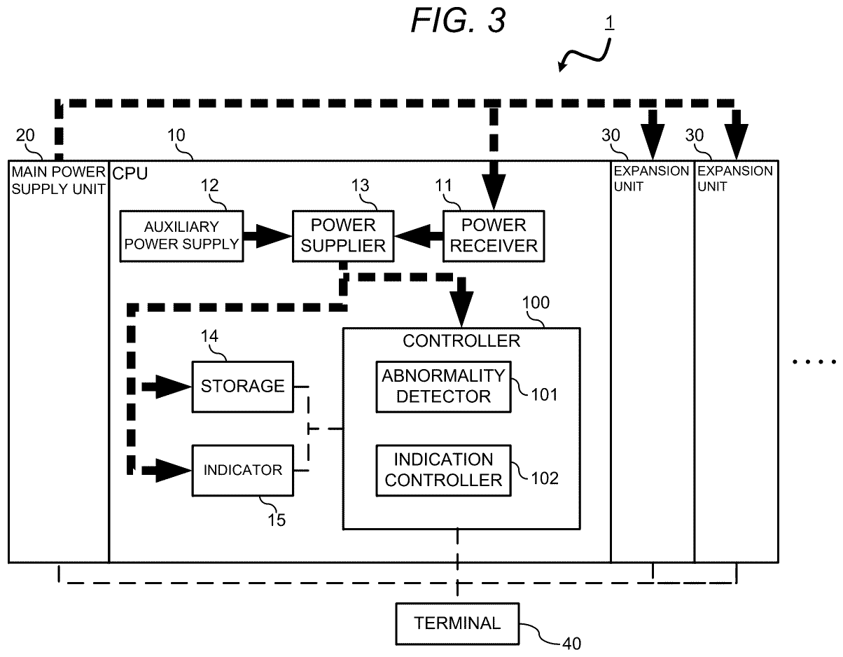

A control system 1 according to Embodiment 2 is described with reference to FIG. 3. The control system 1 according to Embodiment 2 is substantially the same as the control system 1 according to Embodiment 1 illustrated in FIG. 1 except that the CPU 10 is connected to a terminal 40 for mutual communication. The control system 1 according to Embodiment 2 can provide information about an abnormality using the terminal 40, rather than the indicator 15 in the CPU 10 alone.

The indication controller 102 in the controller 100 in Embodiment 2 outputs information about an abnormality to the terminal 40 through communication to provide the information about the abnormality using the terminal 40. When the power receiver 11 receives power from the main power supply unit 20, the power supplier 13 supplies power from the main power supply unit 20 to the controller 100 and the storage 14. Thus, the indication controller 102 can output the information about the abnormality to the terminal 40. When the power receiver 11 receives no power from the main power supply unit 20, the power supplier 13 supplies power from the auxiliary power supply 12 to the controller 100 and the storage 14. Thus, the indication controller 102 can output the information about the abnormality to the terminal 40 in the same manner.

The terminal 40 is connected to the CPU 10 for mutual communication. The terminal 40 provides, based on the communication with the indication controller 102, information about an abnormality to the user. The terminal 40 is a terminal device such as an industrial personal computer, a display device, or a smartphone. The terminal 40 is an example of second indication means in an aspect of the present disclosure.

### Modifications

Although the control system 1 is implemented by the PLC in each embodiment, the control system 1 may be implemented by a unit other than the PLC. For example, the control system 1 may be a master-slave system including one master that receives power from a main power supply and multiple slaves. In this case, the master is an example of a control device in an aspect of the present disclosure, and the slaves and the main power supply are each an example of an external device in an aspect of the present disclosure.

In each embodiment, the auxiliary power supply 12 includes the power source such as a dry-cell battery, a rechargeable battery, or a supercapacitor. However, the auxiliary power supply 12 may receive power from a power source external to the CPU 10. In Embodiment 2 illustrated in FIG. 3, for example, the auxiliary power supply 12 may use the terminal 40 as a power source and receive power from the terminal 40. In this case, without any power from the main power supply unit 20 and with the terminal 40 disconnected to the CPU 10, information about an abnormality is not indicated. However, with the terminal 40 constantly connected to the CPU 10 during maintenance, the operation is less likely to have an issue.

In each embodiment, the abnormality detector 101 included in the controller 100 in the CPU operates on power from the power supplier 13. However, the abnormality detector 101 may not operate on power from the power supplier 13. The abnormality detector 101 may operate simply when the main power supply unit 20 supplies power. In this case as well, abnormality data may be stored when the main power supply unit 20 supplies power. Although the main power supply unit 20 then stops supplying power, the storage 14, the indicator 15, and the indication controller 102 can operate on power from the auxiliary power supply 12, allowing the CPU 10 to provide information about an abnormality.

In each embodiment, the abnormality detector 101 in the controller 100 in the CPU 10 detects an abnormality in the main power supply unit 20, the expansion units 30, or the CPU 10. In some embodiments, the abnormality detector 101 may simply detect an abnormality in some of these units. For example, the abnormality detector 101 may not detect any abnormality in the CPU 10. In this configuration, any abnormality occurring in the CPU 10 is not indicated. However, such configuration may be used when, for example, the user can readily notice that an abnormality occurs in the CPU 10 without receiving indication of the abnormality occurring in the CPU 10. In some embodiments, the abnormality detector 101 may simply detect an abnormality in the CPU 10.

In Embodiment 2, the CPU 10 includes the indicator 15. The indication controller 102 provides information about an abnormality using both the indicator 15 and the terminal 40. In some embodiments, the CPU 10 may not include the indicator 15. The indication controller 102 may provide information about an abnormality using the terminal 40 alone. In this case, the terminal 40 is an example of first indication means in an aspect of the present disclosure.

In each embodiment, the power supplier 13 in the CPU 10 constantly supplies power from the auxiliary power supply 12 to the storage 14, the indicator 15, and the controller 100 when no power is supplied from the main power supply unit 20. However, the power supplier 13 may switch between supplying or not supplying power from the auxiliary power supply 12 based on the user setting when no power is supplied from the main power supply unit 20. When, for example, a normal operation includes an operation with the power supply switch in the main power supply unit 20 turned off for a long time, the power stored in the power source in the auxiliary power supply 12 may be unintendedly consumed. Thus, the switching may set by the user for convenience. For example, a dual in-line package (DIP) switch may be installed in the CPU 10 to set the switching. In Embodiment 2 illustrated in FIG. 3, an engineering tool may be installed in the terminal 40 for the setting.

In setting the CPU 10 using the engineering tool, a type of information to be indicated as information about an abnormality can also be set, in addition to the switching between supplying or not supplying power. For example, the CPU 10 may be set to simply indicate a unit with an abnormality or indicate the details of the abnormality as well.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1 Control system
10 CPU
11 Power receiver
12 Auxiliary power supply
13 Power supplier
14 Storage
15 Indicator
20 Main power supply unit
30 Expansion unit
40 Terminal
100 Controller
101 Abnormality detector
102 Indication controller

1. A control device, comprising:
an auxiliary power supply;
power receiver to receive power from a main power supply;
storage;
abnormality detector to detect an abnormality occurring in at least one device of devices, the devices including the control device and a plurality of external devices, the plurality of external devices including the main power supply, the abnormality detector being for storing, into the storage, abnormality data about the abnormality including data indicating the at least one device with the abnormality;
indication controller to provide, based on the abnormality data stored in the storage, information indicating the at least one device with the abnormality using first indicator; and
power supplier to supply power to the storage means and the indication control means,
wherein the storage and the indication controller operate on power supplied from the power supplier,
the power supplier supplies power from the main power supply when the power receiver receives power from the main power supply, and
the power supplier supplies power from the auxiliary power supply when the power receiver receives no power from the main power supply, a
the control device being a CPU (Central Processing Unit) of a programmable logic controller, and
the plurality of external devices each being a unit of the programmable logic controller managed by the CPU.

2. The control device according to claim 1, further comprising:
the first indicator,
wherein the power supplier further supplies power to the first indicator.

3. The control device according to claim 2, wherein
the indication controller provides the information further using second indicator external to the control device.

4. The control device according to claim 1, wherein
the power supplier switches, based on a user setting, between supplying and not supplying power from the auxiliary power supply when the power receiver receives no power from the main power supply.

5. A control system, comprising:
the control device according to claim 1; and
the plurality of external devices.

6. A control method for a control device, the control device including
an auxiliary power supply,
power receiver to receive power from a main power supply,
storage,
abnormality detector to detect an abnormality occurring in at least one device of devices, the devices including the control device and a plurality of external devices, the plurality of external devices including the main power supply, the abnormality detector being for storing, into the storage, abnormality data about the abnormality including data indicating the at least one device with the abnormality, and
indication controller to provide, based on the abnormality data stored in the storage, information indicating the at least one device with the abnormality using first indicator,
the control device being a CPU (Central Processing Unit) of a programmable logic controller, and
the plurality of external devices each being a unit of the programmable logic controller managed by the CPU,
the method comprising:
supplying power from the main power supply to the storage and the indication control means controller when the power receiver receives power from the main power supply; and
supplying power from the auxiliary power supply to the storage and the indication controller when the power receiver receives no power from the main power supply.
